(19) United States
(12) Patent Application Publication
(10) Pub. No.: US 2026/0299941 A1
(43) Pub. Date: Oct. 1, 2026

(54) METHOD AND SYSTEM FOR GENERATING WORK ITEMS FOR PROJECT MANAGEMENT SYSTEM (PMS)

(71) Applicant: The Capital Markets Company, LLC, New York, NY (US)

(72) Inventors: Matthew WOODARD, Winter Park, FL (US); Chinmoy BHATIYA, Libertyville, IL (US); David de SOUZA, Oviedo, FL (US)

(73) Assignee: The Capital Markets Company, LLC, New York, NY (US)

(21) Appl. No.: 19/305,521

(22) Filed: Aug. 20, 2025

Related U.S. Application Data
(60) Provisional application No. 63/780,159, filed on Mar. 28, 2025.

(51) Int. Cl. G06F 8/77; G06F 21/62

(52) U.S. Cl. CPC G06F 8/77; G06F 21/6218

(57) ABSTRACT

A method for generating work items for Project Management System (PMS) is disclosed. The method includes receiving input data corresponding to a user selected project from a user device. The method includes iteratively generating one or more work items corresponding to a user selected work item type based on a final breakdown prompt using a Large Language Model (LLM). The method includes validating each of the one or more work items based on a set of work item validation parameters. Upon successful validation, for each work item, the method includes generating definition details corresponding to the work item based on a final definition prompt using the LLM. The method includes validating the definition details of the work item based on a set of definition validation parameters. Upon successful validation, the method includes rendering the one or more work items on the user device.

### TECHNICAL FIELD

This disclosure relates generally to project management, and more particularly to method and system for generating work items for Project Management System (PMS).

### BACKGROUND

Business requirements and test case definitions are essential for creating business-critical software via a Software Development Life Cycle (SDLC). Business analysts may utilize requirement files to create the business requirements-based work items (e.g., Epic, Feature, User Story and Test Case) to enable the creation of business-critical software for organizations. This process, however, is slow and delays software delivery. Currently, techniques for creation of business requirements rely on a multitude of manual steps, ranging from gathering business requirements from conversations, documents, and notes to transforming such information into Epics and User Stories. However, the manual process may face several challenges during the SDLC, such as latency and consistency issues, time delays, complexity in processing different types of documents, inefficiency, and low accuracy.

In the present state of art, improvements in Generative Artificial Intelligence (GenAI) and Large Language Models (LLMs) have provided a solution to the above-mentioned problems of manually processing different types of inputs, non-configurable output, non-deterministic delays and latencies. These GenAI and LLM solutions can take different types of inputs (audio, video, any text format etc.) from different sources, ingest them, and automatically create a first draft of business requirements instantly. While LLMs hold immense promise for business analysis, inherent limitations prevent business analysts from simply using out of the box commercially available or open-source models to automate tasks. Such limitations include token limits and finite context windows, propensity for hallucinations, and non-focused prompts.

The existing techniques fail to disclose fully automatic systems which are integrated with a project management tool for determining business requirements for creation of business software. Further, the existing techniques fail to disclose identification of work items at varying levels of granularity from requirement documents. Additionally, the existing techniques fail to disclose prompt orchestration to create prompts that improve performance of the LLM. Further, the existing techniques fail to disclose any adaptive retry mechanism to handle hallucinations and non-deterministic responses from LLM. Additionally, the existing techniques fail to provide customized instructions to LLM as received from the business analyst for creating the business requirement.

The present invention is directed to overcome one or more limitations stated above or any other limitations associated with the known arts.

### SUMMARY

In one embodiment, a method for generating work items for project management system (PMS) is disclosed. In one example, the method may include receiving, via a user interface, input data corresponding to a user selected project from a user device. It should be noted that the input data may include a user selected work item type and a project identifier (ID) corresponding to the user selected project. The method may further include iteratively generating one or more work items corresponding to the user selected work item type based on a final breakdown prompt using a Large Language Model (LLM). The final breakdown prompt may include the input data and a work item-specific breakdown prompt template. The method may further include validating each of the one or more work items based on a set of work item validation parameters. Upon successful validation, for each work item of the one or more work items, the method may further include generating definition details corresponding to the work item based on a final definition prompt using the LLM. The final definition prompt may include the input data, the one or more work items, and a work item-specific definition prompt template. The method may further include validating the definition details of the work item based on a set of definition validation parameters. Upon successful validation, the method may further include rendering, via the user interface, the one or more work items on the user device.

In another embodiment, a system for generating work items for PMS is disclosed. In one example, the system may include a processor and a computer-readable medium communicatively coupled to the processor. The computer-readable medium may store processor-executable instructions, which, on execution, may cause the processor to receive, via a user interface, input data corresponding to a user selected project from a user device. It should be noted that the input data may include a user selected work item type and a project ID corresponding to the user selected project. The processor-executable instructions, on execution, may further cause the processor to iteratively generate one or more work items corresponding to the user selected work item type based on a final breakdown prompt using an LLM. The final breakdown prompt may be the input data and a work item-specific breakdown prompt template. The processor-executable instructions, on execution, may further cause the processor to validate each of the one or more work items based on a set of work item validation parameters. Upon successful validation, for each work item of the one or more work items, the processor-executable instructions, on execution, may further cause the processor to generate definition details corresponding to the work item based on a final definition prompt using the LLM. The final definition prompt may include the input data, the one or more work items, and a work item-specific definition prompt template. The processor-executable instructions, on execution, may further cause the processor to validate the definition details of the work item based on a set of definition validation parameters. Upon successful validation, the processor-executable instructions, on execution, may further cause the processor to render, via the user interface, the one or more work items on the user device.

In yet another embodiment, a non-transitory computer-readable medium storing computer-executable instruction for generating work items for PMS is disclosed. In one example, the stored instructions, when executed by a processor, may cause the processor to perform operations including receiving, via a user interface, input data corresponding to a user selected project from a user device. It should be noted that the input data may include a user selected work item type and a project ID corresponding to the user selected project. The operations may further include iteratively generating one or more work items corresponding to the user selected work item type based on a final breakdown prompt using an LLM. The final breakdown prompt may include the input data and a work item-specific breakdown prompt template. The operations may further include validating each of the one or more work items based on a set of work item validation parameters. Upon successful validation, for each work item of the one or more work items, the operations may further include generating definition details corresponding to the work item based on a final definition prompt using the LLM. The final definition prompt may include the input data, the one or more work items, and a work item-specific definition prompt template. The operations may further include validating the definition details of the work item based on a set of definition validation parameters. Upon successful validation, the operations may further include rendering, via the user interface, the one or more work items on the user device.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for generating work items for project management system (PMS), in accordance with some embodiments of the present disclosure.

FIG. 2 illustrates a functional block diagram of a system for generating work items for PMS, in accordance with some embodiments of the present disclosure.

FIGS. 3A, 3B, and 3C illustrate a flow diagram of an exemplary process for generating work items for PMS, in accordance with some embodiments of the present disclosure.

FIG. 4 illustrates a flow diagram of a detailed exemplary process for generating work items for PMS, in accordance with some embodiments of the present disclosure.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

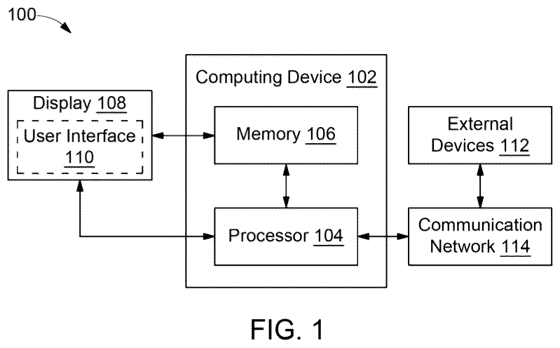

Referring now to FIG. 1, an exemplary system 100 for generating work items for project management system (PMS) is illustrated, in accordance with some embodiments of the present disclosure. The system 100 may include a computing device 102. The computing device 102 may be, for example, but may not be limited to, server, desktop, laptop, notebook, netbook, tablet, smartphone, mobile phone, or any other computing device, in accordance with some embodiments of the present disclosure. The computing device 102 may iteratively generate one or more work items corresponding to user selected work item type using a Large Language Model (LLM). By way of an example, the user selected work item type may be one of, but may not be limited to, Epic, Feature, User Story, and Test Case in Agile.

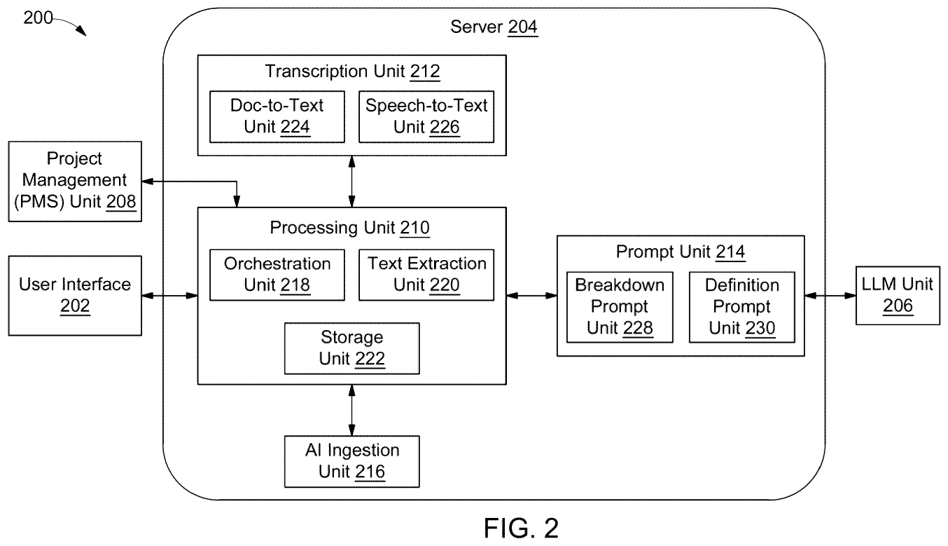

As will be described in greater detail in conjunction with FIG. 2-5, the computing device 102 may receive, via a user interface, input data corresponding to a user selected project from a user device. It should be noted that the input data may include a user selected work item type and a project identifier (ID) corresponding to the user selected project. The computing device 102 may further iteratively generate one or more work items corresponding to the user selected work item type based on a final breakdown prompt using an LLM. The final breakdown prompt may include the input data and a work item-specific breakdown prompt template. The computing device 102 may further validate each of the one or more work items based on a set of work item validation parameters. Upon successful validation, for each work item of the one or more work items, the computing device 102 may generate definition details corresponding to the work item based on a final definition prompt using the LLM. The final definition prompt may include the input data, the one or more work items, and a work item-specific definition prompt template. The computing device 102 may further validate the definition details of the work item based on a set of definition validation parameters. Upon successful validation, the computing device 102 may further render, via the user interface, the one or more work items on the user device.

In some embodiments, the computing device 102 may include one or more processors 104 and a memory 106. Further, the memory 106 may store instructions that, when executed by the one or more processors 104, may cause the one or more processors 104 to generate work items for PMS, in accordance with aspects of the present disclosure. The memory 106 may also store various data (for example, input data, one or more work items, pre-stored projects, created parent work items, a work item-specific breakdown prompt template, a work item-specific definition prompt template, and the like) that may be captured, processed, and/or required by the system 100.

The system 100 may further include a display 108. The system 100 may interact with a user interface 110 accessible via the display 108. The system 100 may also include one or more external devices 112. In some embodiments, the computing device 102 may interact with the one or more external devices 112 over a communication network 114 for sending or receiving various data. The communication network 114 may include, for example, but may not be limited to, a wireless fidelity (Wi-Fi) network, a light fidelity (Li-Fi) network, a local area network (LAN), a wide area network (WAN), a metropolitan area network (MAN), a satellite network, the internet, a fiber optic network, a coaxial cable network, an infrared (IR) network, a radio frequency (RF) network, and a combination thereof. The one or more external devices 112 may include, but may not be limited to, a remote server, a laptop, a netbook, a notebook, a smartphone, a mobile phone, a tablet, or any other computing device.

Referring now to FIG. 2, a functional block diagram of a system 200 for generating work items for PMS is illustrated, in accordance with some embodiments of the present disclosure. FIG. 2 is explained in conjunction with FIG. 1. The system 200 may be analogous to the system 100. The system 200 may implement the computing device 102. The system 200 may include a user interface 202, a server 204, a Large Language Model (LLM) unit 206, and a Project Management System (PMS) unit 208. The user interface 202 may be rendered on a user device (for example, but not limited to, a desktop, a laptop, a notebook, a netbook, a tablet, a smartphone, mobile phone, or any other computing device). The server 204 may be analogous to the computing device 102.

The server 204 may include, within a memory (such as the memory 106), a processing unit 210, a transcription unit 212, a prompt unit 214, and an Artificial Intelligence (AI) ingestion unit 216. The processing unit 210 may include an orchestration unit 218, a text extraction unit 220, and a storage unit 222. The transcription unit 212 may include a doc-to-text unit 224, and a speech-to-text unit 226. The prompt unit 214 may include a breakdown prompt unit 228, and a definition prompt unit 230. In an embodiment, the LLM unit 206 may be hosted in an external server. In an alternative embodiment, the LLM unit 206 may be included in the memory of the server 204. Similarly, in an embodiment, the PMS unit 208 may be hosted in an external server. In an alternative embodiment, the PMS unit 208 may be included in the memory of the server 204.

Initially, the orchestration unit 218 may receive, via the user interface 202, a set of login credentials corresponding to a user from the user device. The login credentials may be unique to the user only. For example, the set of login credentials, may include, but may not be limited to, username, user password, or the like. Further, the orchestration unit 218 may authenticate the set of login credentials corresponding to the user to ensure that the user may have necessary permissions for access.

Upon successful authentication, the orchestration unit 218 may send a request to a project storage database within the PMS unit 208 for project details corresponding to each of one or more pre-stored projects associated with the user. For example, the PMS unit 208 may be, but may not be limited to, JIRA, Azure DevOps (ADO), and the like. For example, the project details, may include, but may not be limited to, a project name, a project ID, details of previously generated parent work items (such as, work item name, work item ID, work item description, etc.) (if any), previously generated potential child work item names corresponding to the parent work items (if any), an account, a sector, location, initiation date, client name, delivery manager name, project manager name, or the like.

Further, the orchestration unit 218 may retrieve the project details corresponding to each of the one or more pre-stored projects associated with the user from the project storage database within the PMS unit 208 based on the request. Further, the orchestration unit 218 may parse the project details to make it more readable, and usable for further processing. Also, the orchestration unit 218 may keep checking for fault(s) that may arise during the retrieval of the project details. Further, the orchestration unit 218 may render, via the user interface 202, the one or more pre-stored projects and the corresponding parsed project details on the user device.

The one or more pre-stored projects and the corresponding project details may be rendered in form of a dashboard, a report, a detailed project view, or the like. In some embodiments, if the orchestration unit 218 may find any fault(s) during the retrieval of the project details, the orchestration unit 218 may render, via the user interface 202, a fault notification corresponding to the encountered fault(s) on the user device.

Further, the orchestration unit 218 may receive, via the user interface 202, the user selected project from the user device. The user selected project is one of the one or more pre-stored projects or a new user selected project. Upon receiving the user selected project, the orchestration unit 218 may identify whether the user selected project is selected from a group consisting of the one or more pre-stored projects or the new user selected project. When the user selected project is one of the one or more pre-stored projects, the orchestration unit 218 may determine whether the user selected project may include one or more created parent work items. Further, based on the identifying and determining, the orchestration unit 218 may render, via the user interface 202, a set of work item types on the user device. For example, the set of work item types, may include, but may not be limited to, Epic, Feature, User Story, Test Case, Task, or the like.

Further, the orchestration unit 218 may receive, via the user interface 202, the user selected work item type from the set of work item types. Thus, the orchestration unit 218 may receive, via the user interface 202, input data corresponding to the user selected project from the user device. The input data may include the user selected work item type and the project ID corresponding to the user selected project. Further, the orchestration unit 218 may render, via the user interface 202, an option to provide one or more requirement files and user instructions corresponding to the user selected work item type. The one or more requirement files may be received in a format of, for example, audio file, video file, image, Portable Document Format (PDF), text, DOC (or DOCX), Power Point Presentation (PPT), spreadsheet, transcripts, or the other similar formats.

In some embodiments, if the user may provide one or more requirement files, the orchestration unit 218 may send the one or more requirement files and the corresponding project ID to the text extraction unit 220. Further, the text extraction unit 220 may send the one or more requirement files and the corresponding project ID to either of the doc-to-text unit 224 (or the speech-to-text unit 226) based on the file format of received one or more requirement files.

By way of an example, when the text extraction unit 220 may receive the one or more requirement files in the format of audio (or video), in such cases, the text extraction unit 220 may send the one or more requirement files to the speech-to-text unit 226. When the text extraction unit 220 may receive the one or more requirement files in other formats (i.e., text, DOC, PDF, PPT, or the like), in such cases, the text extraction unit 220 may send the one or more requirement files to the doc-to text unit 224.

Further, the speech-to-text unit 226 (or the doc-to-text unit 224) may extract the text from the respective one or more requirements files. Further, the speech-to-text unit 226 (or the doc-to-text unit 224) may send the extracted text, a notification (i.e., ‘success’ or ‘error’), and the corresponding project ID to the text extraction unit 220. Upon successful text extraction from the one or more requirement files, the speech-to-text unit 226 (or the doc-to-text unit 224) may send the extracted text, a ‘success’ notification, and the corresponding project ID to the text extraction unit 220. Alternatively, when the speech-to-text unit 226 (or the doc-to-text unit 224) may find any error while extracting the text from the one or more requirement files, the speech-to-text unit 226 (or the doc-to-text unit 224) may send an ‘error’ notification to the text extraction unit 220.

If the text extraction unit 220 may receive the extracted text along with the ‘success’ notification, the text extraction unit 220 may store the extracted text along with the corresponding project ID in the storage unit 222. In some embodiments, if the storage unit 222 may include any previously stored extracted text corresponding to the project ID, the text extraction unit 220 may append the newly received extracted text to the previous stored extracted text to obtain updated extracted text. If the text extraction unit 220 may receive the ‘error’ notification, the text extraction unit 220 may send the ‘error’ notification to the orchestration unit 218.

Alternatively, if the user may not provide any requirement files corresponding to the user selected work item type, the text extraction unit 220 may obtain (or retrieve) the previously stored extracted text corresponding to the user selected work item type using the project ID from the storage unit 222. It should be noted that the previously extracted text corresponding to each project ID may be priorly stored in the storage unit 222. Upon extracting the text, the text extraction unit 220 may send the extracted text to the orchestration unit 218. The extracted text may be either same as received from the transcription unit 212, updated extracted text (i.e., appended extracted text), or previously stored extracted text.

Further, the orchestration unit 218 may send the input data, historical project data corresponding to the user selected project, details of the parent work item of the user selected work item type (if available), the set of potential child work item names of the parent work item, the one or more requirement files (if available), and the user instructions (if any) to the breakdown prompt unit 228.

Further, the breakdown prompt unit 228 and the LLM unit 206 may iteratively generate one or more work items corresponding to the user selected work item type based on a final breakdown prompt using an LLM. The LLM may be included within the LLM unit 206. By way of an example, the LLM may be, but may not be limited to, Generative Pre-trained Transformer (GPT)-3, GPT-3.5, GPT-4, Language Model for Dialogue Applications (LaMDA), Pathways Language Model (PaLM), Gemini, Claude, BigScience Large Open-science Open-access Multilingual Language Model (BLOOM), Large Language Model Meta AI (Llama), Mistral 7B, Mixtral 8x7B, Mixtral 8x22B, or the like. The final breakdown prompt may include the input data and a work item-specific breakdown prompt template.

To iteratively generate the one or more work items, the breakdown prompt unit 228 may select the work item-specific breakdown prompt template (i.e., a fixed breakdown prompt) from a set of breakdown prompt templates based on the user selected work item type. Further, the breakdown prompt unit 228 may generate a dynamic breakdown prompt using the input data, the historical project data corresponding to the user selected project, details of the parent work item of the user selected work item type, the set of potential child work item names of the parent work item, the one or more requirement files, the user instructions, and a predefined dynamic breakdown prompt template.

Further, the breakdown prompt unit 228 may create the final breakdown prompt based on the work item-specific breakdown prompt template and the dynamic breakdown prompt. The final breakdown prompt may include the input data and the work item-specific breakdown prompt template. Further, the breakdown prompt unit 228 may provide the final breakdown prompt to the LLM unit 206. Upon receiving the final breakdown prompt, for each one or more iterations, the LLM unit 206 may generate, via the LLM, a first work item corresponding to the user selected work item type, in response to the final breakdown prompt. Upon generating the first work item, the LLM unit 206 may determine, via the LLM, whether a work item type of the first work item corresponds to a parent work item. When the work item type of the first work item corresponds to the parent work item, the LLM unit 206 may generate, via the LLM, the set of potential child work item names of the first work item in response to the final breakdown prompt.

Further, the LLM unit 206 may add, via the LLM, the set of potential child work item names of the first work item to the final breakdown prompt. Further, the LLM unit 206 may generate, via the LLM, a set of child work items corresponding to the first work item in response to the final breakdown prompt. The one or more work items may include the first work item and the set of child work items. Further, the LLM unit 206 may send the one or more work items to the breakdown prompt unit 228. Further, the breakdown prompt unit 228 may send the one or more work items to orchestration unit 218.

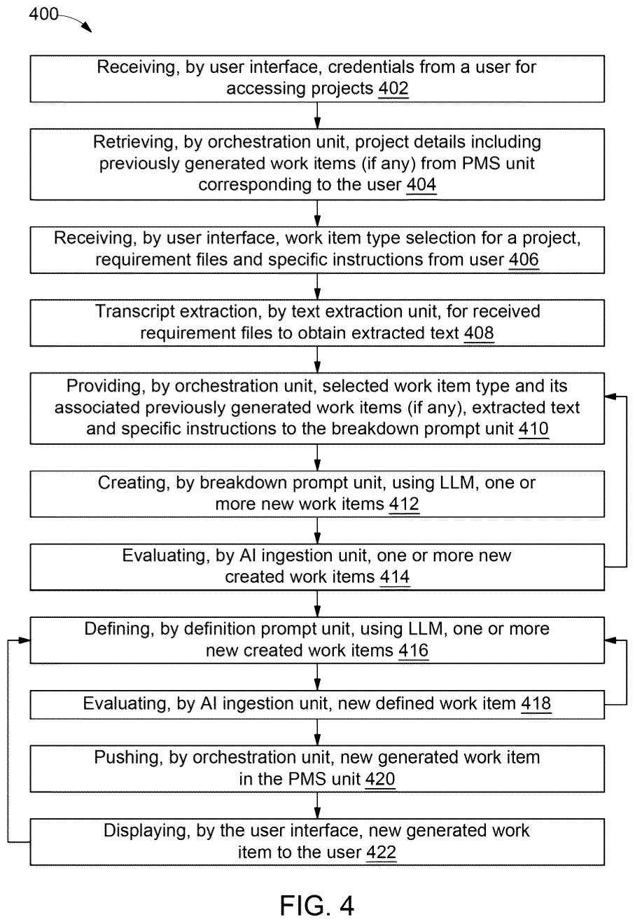

Further, the orchestration unit 218 may send the one or more work items to the AI ingestion unit 216. Further, the AI ingestion unit 216 may validate each of the one or more work items based on a set of work item validation parameters. To validate the one or more work items, the AI ingestion unit 216 may perform one or more checks on each of the one or more work items based on a first set of predefined format rules and a set of predefined data coverage rules. This is further explained in greater detail in conjunction with FIG. 4. Further, the AI ingestion unit 216 may send a validation response (e.g., ‘Pass’ or ‘Failure’) to the orchestration unit 218.

When the one or more checks performed on each of the work items are passed, the validation is successful. In such embodiments, the orchestration unit 218 may send the input data corresponding each of the one or more work items to the definition prompt unit 230. When the one or more checks performed on the work items are failed, the validation is unsuccessful. In such embodiments, the orchestration unit 218 may render, via the user interface 202, a process termination message on the user device.

Further, the definition prompt unit 230 and the LLM unit 206 may generate definition details corresponding to the work item based on a final definition prompt using the LLM. The final definition prompt may include the input data, the one or more work items, and a work item-specific definition prompt template.

To generate the definition details, for each work item of the one or more work items, the definition prompt unit 230 may select a work item-specific prompt template from a set of definition prompt templates based on the user selected work item type. Upon selecting the work item-specific prompt template, the definition prompt unit 230 may generate a dynamic definition prompt using the input data, the work item, historical project data corresponding to the user selected project, details of a parent work item of the user selected work item type, a set of potential child work item names of the parent work item, the one or more requirement files, the user instructions, and a predefined dynamic definition prompt template.

Further, the definition prompt unit 230 may create a final definition prompt based on the work item-specific definition prompt template and the dynamic definition prompt. Further, the definition prompt unit 230 may provide the final definition prompt to the LLM unit 206. Further, the LLM unit 206 may generate definition details corresponding to the work item based on the final definition prompt using the LLM. Further, the LLM unit 206 may provide the definition details corresponding to each of the one or more work items to the definition prompt unit 230. Further, the definition prompt unit 230 may provide the definition details to the orchestration unit 218. Further, the orchestration unit 218 may send the definition details to the AI ingestion unit 216.

Further, the AI ingestion unit 216 may validate the definition details of the work item based on a set of definition parameters. To validate the definition details of the work item, the AI ingestion unit 216 may perform one or more checks on the definition details based on a second set of predefined format rules and a second set of predefined data coverage rules. This is further explained in greater detail in conjunction with FIG. 4.

When each of the checks performed on the definition details of the work item is passed, validation is successful. In such embodiments, the orchestration unit 218 may send the one or more work items to the PMS unit 208.

When the one or more checks performed on the definition details of the work item is failed, the validation is unsuccessful. Further, the PMS unit 208 may store each of the one or more work items in the corresponding user selected project within the project storage database. Further, the orchestration unit 218 may render (or display), via the user interface 202, the one or more work items on the user device.

It should be noted that all such aforementioned modules 206-230 may be represented as a single unit/module or a combination of different units/modules. Further, as will be appreciated by those skilled in the art, each of the units/modules 206-230 may reside, in whole or in parts, on one device or multiple devices in communication with each other. In some embodiments, each of the units/modules 206-230 may be implemented as dedicated hardware circuit comprising custom application-specific integrated circuit (ASIC) or gate arrays, off-the-shelf semiconductors such as logic chips, transistors, or other discrete components. Each of the units/modules 206-230 may also be implemented in a programmable hardware device such as a field programmable gate array (FPGA), programmable array logic, programmable logic device, and so forth. Alternatively, each of the units/modules 206-230 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for generating work items for PMS. For example, the exemplary system 100 and the associated computing device 102, may generate work items for PMS, by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

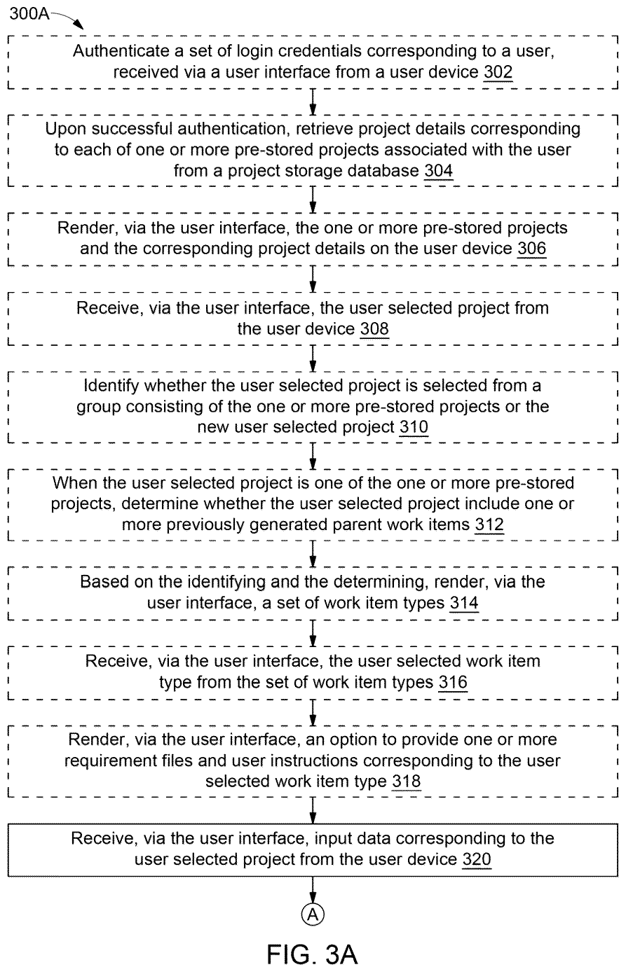

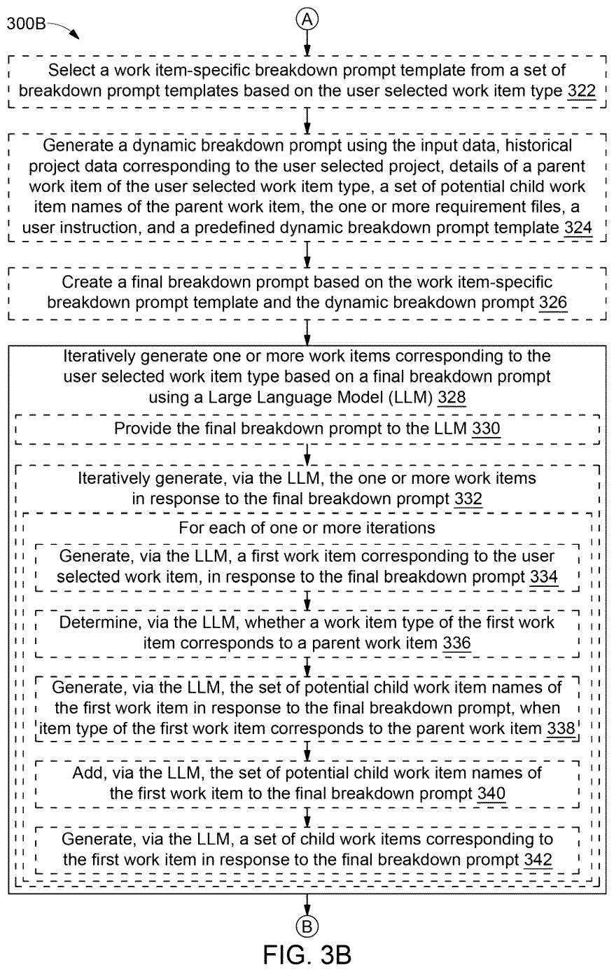

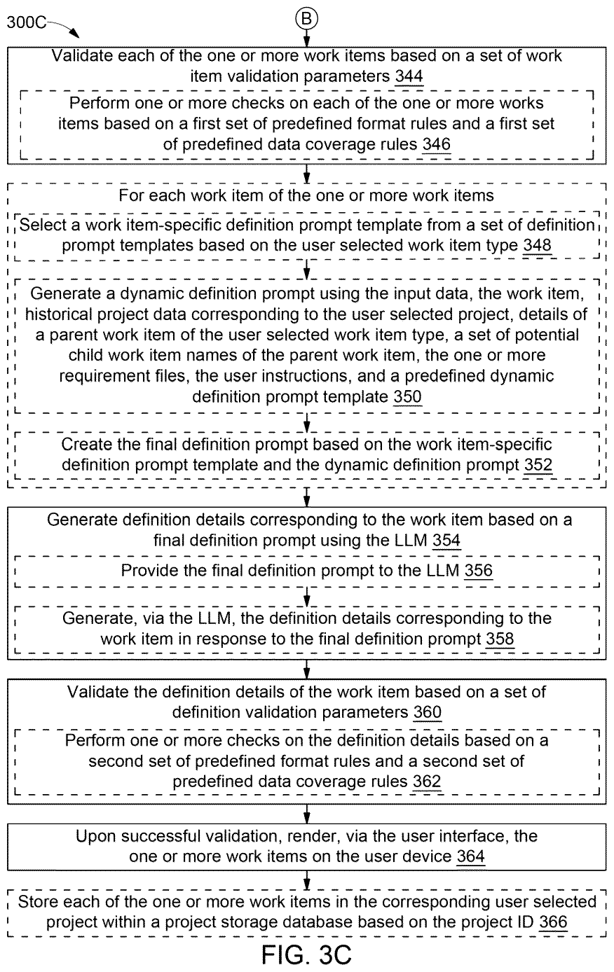

Referring now to FIGS. 3A, 3B, and 3C an exemplary process 300 for generating work items for PMS is illustrated via a flow chart, in accordance with some embodiments of the present disclosure. FIGS. 3A, 3B, and 3C are explained in conjunction with FIGS. 1 and 2. The process 300 may be implemented by the computing device 102 of the system 100. In some embodiments, the process 300 may include authenticating, by an orchestration unit (such as the orchestration unit 218), a set of login credentials corresponding to a user, received via a user interface (such as the user interface 202) from a user device, at step 302.

Upon successful authentication, the process 300 may include retrieving, by the orchestration unit, project details corresponding to each of one or more pre-stored projects associated with the user from a project storage database, at step 304. Upon retrieving the project details, the process 300 may include rendering, by the orchestration unit via the user interface, the one or more pre-stored projects and the corresponding project details on the user device, at step 306. Further, the process 300 may include receiving, by the orchestration unit via the user interface, the user selected project from the user device, at step 308. The user selected project is one of the one or more pre-stored projects or a new user selected project.

Upon receiving the user selected project, the process 300 may include identifying, by the orchestration unit, whether the user selected project is selected from a group consisting of the one or more pre-stored projects or the new user selected project, at step 310. When the user selected project is one of the one or more pre-stored projects, the process 300 may include determining, by the orchestration unit, whether the user selected project may include one or more created parent work items, at step 312. Further, based on the identifying and the determining, the process 300 may include rendering, by the orchestration unit via the user interface, a set of work item types, at step 314. Further, the process 300 may include receiving, by the orchestration unit via the user interface, the user selected work item type from the set of work item types, at step 316.

Upon receiving the user selected work item type, the process 300 may include rendering, by the orchestration unit via the user interface, an option to provide one or more requirement files and user instructions corresponding to the user selected work item type, at step 318. Further, the process 300 may include receiving, by the orchestration unit via the user interface, input data corresponding to the user selected project from the user device, at step 320.

Once the input data is received, the process 300 may include selecting, by a breakdown prompt unit (such as the breakdown prompt unit 228) a work item-specific breakdown prompt template from a set of breakdown prompt templates based on the user selected work item type, at step 322. Further, the process 300 may include generating, by the breakdown prompt unit, a dynamic breakdown prompt using the input data, historical project data corresponding to the user selected project, details of a parent work item of the user selected work item type, a set of potential child work item names of the parent work item, the one or more requirement files, the user instructions, and a predefined dynamic breakdown prompt template, at step 324.

Further, the process 300 may include creating, by the breakdown prompt unit, a final breakdown prompt based on the work item-specific breakdown prompt template and the dynamic breakdown prompt, at step 326. The final breakdown prompt may include the input data, and the work item-specific breakdown prompt.

Upon generating the final breakdown prompt, the process 300 may include iteratively generating, by a LLM unit (such as the LLM unit 206) and the breakdown prompt unit, one or more work items corresponding to the user selected work item type based on the final breakdown prompt using an LLM, at step 328. The step 328 may include steps 330, 332, 334, 336, 338, 340, and 342.

To iteratively generate the one or more work items, the process 300 may include providing, by the breakdown prompt unit, the final breakdown prompt to the LLM, at step 330. Further, the process 300 may include iteratively generating, by the LLM unit via the LLM, the one or more work items in response to the final breakdown prompt, at step 332. Further, for each of one or more iterations, the process 300 may include generating, by the LLM unit via the LLM, a first work item corresponding to the user selected work item type, in response to the final breakdown prompt, at step 334.

Upon generating the first work item, the process 300 may include determining, by the LLM unit via the LLM, whether a work item type of the first work item corresponds to a parent work item, at step 336. When the work item type of the first work item corresponds to the parent work item, the process 300 may include generating, by the LLM unit via the LLM, the set of potential child work item names of the first work item in response to the final breakdown prompt, at step 338.

Further, the process 300 may include adding, by the LLM unit via the LLM, the set of potential child work item names of the first work item to the final breakdown prompt, at step 340. Further, the process 300 may include generating, by the LLM unit via the LLM, a set of child work items corresponding to the first work item in response to the final breakdown prompt, at step 342. The one or more work items may include the first work item and the set of child work items.

Once the one or more work items are generated, the process 300 may include validating, by an AI ingestion unit (such as the AI ingestion unit 216), each of the one or more work items based on a set of work item validation parameters, at step 344. To validate the one or more work items, the process 300 may include performing, by the AI ingestion unit, one or more checks on each of the one or more work items based on a first set of predefined format rules and a first set of predefined data coverage rules, at step 346.

Upon successful validation, for each work item of the one or more work items, the process 300 may include selecting, by a definition prompt unit (such as the definition prompt unit 230), a work item-specific definition prompt template from a set of definition prompt templates based on the user selected work item type, at step 348. Further, the process 300 may include generating, by the definition prompt unit, a dynamic definition prompt using the input data, the work item, historical project data corresponding to the user selected project, details of a parent work item of the user selected work item type, a set of potential child work item names of the parent work item, the one or more requirement files, the user instructions, and a predefined dynamic definition prompt template, at step 350. Further, the process 300 may include creating, by the definition prompt unit, the final definition prompt based on the work item-specific definition prompt template and the dynamic definition prompt, at step 352. The final definition prompt may include the input data, the one or more work items, and a work item-specific definition prompt template.

Upon creating the final definition prompt, the process 300 may include generating, by the LLM unit and the definition prompt unit, definition details corresponding to the work item based on the final definition prompt using the LLM, at step 354. To generate the definition details, the process 300 may include providing, by the definition prompt unit, the final definition prompt to the LLM, at step 356. Further, the process 300 may include generating, by the LLM unit via the LLM, the definition details corresponding to the work item in response to the final definition prompt, at step 358.

Once the definition details are generated, the process 300 may include validating, by the AI ingestion unit, the definition details of the work item based on a set of definition validation parameters, at step 360. To validate the definition details, the process 300 may include performing, by the AI ingestion unit, one or more checks on the definition details based on a second set of predefined format rules and a second set of predefined data coverage rules, at step 362.

Upon successful validation, the process 300 may include rendering, by the orchestration unit via the user interface, the one or more work items on the user device, at step 364. Further, the process 300 may include storing, by the PMS unit, each of the one or more work items in the corresponding user selected project within a project storage database based on the project ID, at step 366.

Referring now to FIG. 4, a detailed exemplary process 400 for generating work items for PMS is illustrated via a flow chat, in accordance with some embodiments of the present disclosure. FIG. 4 is explained in conjunction with FIGS. 1, 2, and 3A-3D. The process 400 may be implemented by the computing device 102 of the system 100. The process 400 may include receiving, by the user interface 202, a set of login credentials from a user (e.g., a business analyst) for accessing one or more projects, at step 402.

Initially, the user may provide the set of login credentials to the user device through the user interface 202. The set of login credentials may include username and password for logging in. In some embodiments, the logging may also be done using multi-factor authentication. The set of login credentials may be unique to the user only, so that project details corresponding only to the user may be retrieved. Further, the user interface 202 may provide the set of login credentials corresponding to the user to the orchestration unit 218.

Further, the process 400 may include retrieving, by the orchestration unit 218, the project details including previously generated work items corresponding to the user from the PMS unit 208, at step 404. To retrieve the project details, the orchestration unit 218 may authenticate the set of login credentials corresponding to the user to ensure that the user may have necessary permission to access the project details. Upon the successful authentication, the orchestration unit 218 may send a request to the PMS unit 208 (e.g., ADO or JIRA) for the project details corresponding to the set of login credentials of the user.

The request may be structured to fetch project details corresponding the one or more projects (i.e., one or more pre-stored projects) associated with the user. For example, the project details may include project name, project ID, or the like. In some embodiments, if the one or more projects may include the previously generated work item(s), in such cases, the fetched project details may also include details of the previously generated work item(s) (e.g., work item name, work item ID, work item description, etc.) and previously stored potential names list for the child work items corresponding to the previously generated work item(s).

By way of an example, if ‘Epic’ work items have already been generated for a project, the fetched project details may include ‘Epic name’, ‘Epic ID’, ‘Epic description’, or the like. Additionally, the potential names list for ‘Features’ corresponding to the ‘Epic’ work items may also be fetched from the PMS unit 208. In some embodiments, the project details may also include one or more additional information (such as account, sector, location, initiation date, client name, delivery manager name, project manager name, quality coordinator etc.).

Upon retrieving the project details, the orchestration unit 218 may parse the project details corresponding to each of the one or more projects to make it readable, and usable for further processing. In particular, the orchestration unit 218 may convert the raw data (i.e., the project details) into a structured format that may be presented (or displayed). Also, the orchestration unit 218 may keep checking for fault(s) that may arise during the retrieval of the project details. Further, the orchestration unit 218 may provide the parsed project data (or fault notification corresponding to the encountered fault(s)) to the user interface 202 for displaying to the user.

Further, the process 400 may include receiving, by the user interface 202, a work item type selection (i.e., a user selected work item type) for a project (i.e., a user selected project), one or more requirement files, and specific instructions from the user, at step 406. If the user interface 202 may receive the parsed project data from the orchestration unit 218, the user interface 202 may display (or render) the parsed project data to the user on the user device. The parsed project data may be displayed in one of a dashboard format, a report format, or a detailed project view format. If the user interface 202 may receive the fault notification from the orchestration unit 218, the user interface 202 may display the fault notification to the user on the user device and no further steps may be executed. This may ensure that the user is informed of any problems and accordingly, the user can take corrective actions.

Further, the user may select the project from the displayed one or more projects on the user interface 202. Upon selecting the project, the user may select the work item type from a set of work item types (for example, Epic, Feature, User Story, and Test Case in Agile) corresponding to the selected project from the user interface 202 for generation of the work item(s).

If the selected project may be a new project, then the selected project may not have any prior work items available. In such embodiments, the user may get only limited options for the work item type selection. For example, the work item type (i.e., only ‘Epic’) may be available on the user interface 202 for user selection. The user may select the work item type through one of, dropdown, expand button, radio button, etc.

If the selected project may not be a new project, but there may be no prior work items available in the received project details, then the user may also get limited option for work item type selection. For example, only ‘Epic’ option may be available on the user interface 202 for user selection.

If the selected project may not be a new project and there may be prior work items (i.e., parent work items) available in the received project details, then the user may get an option to select the work item type with the parent (i.e., from one of ‘Feature’, ‘User Story’, or ‘Test Case’) in the user interface 202. Also, the user may get an option to select one of the previously generated parent work item(s).

By way of an example, the selected project may include the previously generated parent work item (i.e., ‘epic’) and the previously generated works of ‘Epics’ (such as, ‘Epic 1’, ‘Epic 2’, ‘Epic 3’ and ‘Epic 4’). If the user may want to generate ‘features’ corresponding to the ‘epic 3’, the user may select both the ‘feature’ work item type and the ‘Epic 3’ in the user interface 202. Further, the potential names list (i.e. potential features) may also be shortlisted corresponding to the ‘Epic 3’.

By way of another example, the selected project may already include the generated parent work item (i.e., ‘Epic’ and ‘Feature’) and the previously generated ‘Epic’ works (such as ‘Epic 1’ and ‘Epic 2’). The previously generated ‘Features’ for the ‘Epic 1’ may be ‘Feature 1’ and ‘Feature 2’, and the previously generated ‘Features’ for the ‘Epic 2’ may be ‘Feature 3’ and ‘Feature 4’. If the user may want to generate ‘user story’ corresponding to the ‘Feature 3’ of the ‘Epic 2’, then the user may select the ‘User Story’ work item type, the ‘Feature 3’ and the ‘Epic 2’ in the user interface 202. Further, the potential names list (i.e. potential user stories) may also be shortlisted corresponding to the ‘Feature 3’ of the ‘Epic 2’.

Upon selecting the project and the corresponding work item type, the user may get another option to upload the one or more requirement files. Additionally, the user may get an option to provide specific instructions on the user interface 202 of the user device. For example, it is mandatory for the user to upload, via the user interface 202, the one or more requirement files, when the ‘Epic’ may be selected for the work item generation request. Thus, if the user may not upload any requirement files for the ‘Epic’, no further steps may be executed.

On the other hand, it is optional for the user to upload the one or more requirement files, when the other work item types (i.e., the ‘feature’, the ‘User Story’ and the ‘Test Case’) may be selected for the work item generation request. In such embodiments, the previously uploaded one or more requirement files may be used for the work item(s) generation. Additionally, it is optional for the user to provide specific instructions. In an embodiment, the user may provide the one or more requirement files corresponding to the selected work item type.

Once the user may provide all the input data, the user may trigger the work item generation request on the user interface 202. The input data may include the selected work item type, the selected project via the user, the corresponding parent details along with the potential names list of the selected work item type (if any), the one or more requirement files (if available), and the specific instructions (if any). Further, the user interface 202 may provide all the input data along with the corresponding project ID to the orchestration unit 218. Further, the orchestration unit 218 may send the received one or more requirement files and the corresponding project ID to the text extraction unit 220.

Further, the process 400 may include extracting, by the text extraction unit 220, transcript for the received one or more requirement files to obtain extracted text, at step 408. If the text extraction unit 220 may receive the one or more requirement files and the corresponding project ID from the orchestration unit 218. In such embodiments, if the text extraction unit 220 may receive the one or more requirement files in audio/video type (or format), in such cases, the text extraction unit 220 may send the one or more requirement files to the speech-to-text unit 226 for extracting text from such requirement files.

Also, the text extraction unit 220 may send the project ID to the speech along with requirement files to keep track of project of the extracted text. Further, the speech-to-text unit 226 may extract the text from the one or more requirement files using the LLM. The LLM may be the part of the speech-to-text unit 226 or may be remotely located. If the text extraction unit 220 may receive the one or more requirement files in other formats (e.g., PPT, excel, image, PDF, DOC, transcript, etc.), then the text extraction unit 220 may send the one or more requirement files along with the corresponding project ID to the doc-to-text unit 224 for extracting text from such requirement files. Further, the doc-to-text unit 224 may extract the text from the one or more requirement files using customized local modules (or NLP libraries).

Further, the speech-to-text unit 226 (or the doc-to-text unit 224) may provide the extracted text corresponding to the respective requirement files to the text extraction unit 220. Additionally, the speech-to-text unit 226 (or the doc-to-text unit 224) may provide the corresponding project ID and a notification (i.e., ‘success’ or ‘error’) to the text extraction unit 220.

When the speech-to-text unit 226 (or the doc-to-text unit 224) may successfully extract the text from the respective one or more requirement files, in such cases, the speech-to-text unit 226 (or the doc-to-text unit 224) may send a ‘success’ notification to the text extraction unit 220.

When the speech-to-text unit 226 (or the doc-to-text unit 224) may find any error while extracting text from the perspective one or more requirements, in such cases, the speech-to-text unit 226 (or the doc-to-text unit 224) may send an ‘error’ notification to the text extraction unit 220.

Further, if the text extraction unit 220 may receive the extracted text along with the ‘success’ notification, then the text extraction unit 220 may store the extracted text along with the project ID in the storage unit 222. In some embodiments, if the storage unit 222 may include any previously stored extracted text corresponding to the received project ID, the text extraction unit 220 may append the newly received extracted text to the previously stored extracted text to store updated extracted text. Further, the text extraction unit 220 may obtain the updated extracted text from the storage unit 222. Upon storing the extracted text, the text extraction unit 220 may send the ‘success’ notification to the orchestration unit 218. Further, the orchestration unit 218 may render, via the user interface 202, the ‘success’ notification on the user device.

If the text extraction unit 220 may receive the ‘error’ notification, then no further steps may be executed. Further, the text extraction unit 220 may send the ‘error’ notification to the orchestration unit 218. Further, the orchestration unit 218 may render the ‘error’ notification on the user device via the user interface 202.

In some embodiments, if the text extraction unit 220 may not receive any requirement files, the text extraction unit 220 may obtain (or extract) the previously stored extracted text from the storage unit 222 using the project ID. It should be noted that the previously stored extracted text corresponding to each project ID may be priorly stored in the storage unit 222. Further, the text extraction unit 220 may send the received extracted text along with the project ID to the orchestration unit 218. The extracted text may be one of, same as received from the transcription unit 212, the updated extracted text (i.e., by appending the received extracted text to the previously stored extracted text), the previously stored extracted text in the storage unit 222.

Upon obtaining the extracted text and the project ID, the process 400 may include providing, by the orchestration unit 218, the selected work item type and its associated previously generated work item (if any), the extracted text, and the specific instructions to the breakdown prompt unit 228, at step 410. The orchestration unit 218 may determine whether the selected work item type may include the previously generated parent work item(s) or not. Further, based on the determination, the orchestration unit 218 may send selective data to the breakdown prompt unit 228.

By way of an example, if the selected work item type may be ‘Epic’, then the orchestration unit 218 may share (or provide) the project ID, the selected work item type (i.e., Epic), the corresponding extracted text, and the specific instructions (if any) to the breakdown prompt unit 228.

If the selected work item type may be ‘feature’, or ‘user story’ or ‘Test Case’, then the orchestration unit 218 may share the project ID, the selected work item type (i.e. ‘Feature, or ‘User Story’ or ‘Test Case’), the corresponding parent details (i.e. the work item name, the work item description, etc.) along with the potential names list of the selected work item type, and the specific instructions (if available) to the breakdown prompt unit 228.

Upon receiving the selective data, the process 400 may include creating, by the breakdown prompt unit 228, one or more work items using the LLM, at step 412. The breakdown prompt unit 228 may include two prompts (i.e., one may be a fixed prompt, and the other may be a dynamic prompt). The breakdown prompt unit 228 may be used to prepare a final breakdown prompt using the selective data, the fixed breakdown prompt and the dynamic breakdown prompt.

To prepare the final breakdown prompt, the breakdown prompt 228 may select a fixed breakdown prompt (i.e., a work item-specific breakdown prompt template) from a set of predefined fixed breakdown prompts (i.e., a set of breakdown prompt templates) based on the selective work item type. The breakdown prompt unit 228 may include four fixed breakdown prompts corresponding to each of the work items type (i.e., one fixed breakdown prompt for each of the work item types (i.e., the ‘Epic’, the ‘Feature’, the ‘User Story’, the ‘Test Case’). Further, the breakdown prompt unit 228 may select (or pick) the one fixed breakdown prompt corresponding to the selected work item type.

The fixed breakdown prompt structure may include a definition of the work item being created (i.e., the ‘Epic’, the ‘Feature’, the ‘User Story’, the ‘Test Case’), concise explanation of the process for breaking this work item down, a mock example of some context data and the breakdown of it, guidelines for creating the potential names list for the corresponding child work items (i.e., while creating the ‘Epic, ‘Feature’, ‘User Story’, and the ‘Test Case’), detailed structure description (i.e., explanation of the exact JavaScript Object Notation (JSON) object structure expected from the LLM unit 206), a minimal structure example (e.g., a basic JSON object showing the correct key-value pairs), and a template and placeholder (e.g., a more fleshed-out example with descriptive placeholders that may guide the LLM unit 206 on the type of content to generate for each key).

Further, the breakdown prompt unit 228 may generate a dynamic breakdown prompt using a predefined prompt template (i.e., a predefined dynamic breakdown prompt template) and the previously generated work items (if any) associated to the selected work item type, the extracted text, and the specific instructions (if any). The breakdown prompt unit 28 may include a single dynamic breakdown prompt template for all the four work items type. However, the content within fields of the dynamic definition prompt template may vary corresponding to each of the four work items type.

Upon adjusting the content of the breakdown prompt template corresponding to the selected work item type, the breakdown prompt unit 228 may add the received details (i.e., the project ID, the extracted text, the specific instructions (if any), the parent details (such as the work item ID, the work item name, the work item description, etc.) and the potential names list (if any)) to the dynamic breakdown prompt template to generate the dynamic breakdown prompt.

The dynamic breakdown prompt template may include a source label. The source label may provide the received details as well as source information from where each piece of the received details is coming from (e.g., the project ID, the parent work item(s), and the corresponding potential names list (if any) may be received from the PMS unit 208, the extracted text may be obtained from the one or more requirement files received from the user) to make the LLM unit 206 aware that the received details is coming from the different sources and accordingly prioritize it. The data in the source label may be temporarily stored in the breakdown prompt unit 228 corresponding to each of the received details. Also, the data may be available only for the ongoing prompt session duration. The dynamic breakdown prompt template may also include specific instructions (e.g., the specific instructions (if any) received from the user may also be added to the dynamic breakdown prompt).

Further, the breakdown prompt unit 228 may create one or more work items using the LLM and a final breakdown prompt formed by the combination of the fixed breakdown prompt and the dynamic breakdown prompt. To create the one or more work items, the breakdown prompt unit 228 may create the final breakdown prompt by combining the fixed breakdown prompt and the dynamic breakdown prompt corresponding to the selected work item type. Upon creating the final breakdown prompt, the breakdown prompt unit 228 may send the final breakdown prompt to LLM unit 206. Further, for each work item of the one or more work items, the LLM unit 206 may generate, via the LLM, a first work item corresponding to the selected work item type, in response to the final breakdown prompt. Upon generating the first work item, the LLM unit 206 may determine, via the LLM, whether a work item type of the first work item corresponds to a parent work item (i.e., the previously generated work item(s)).

When the work item type of the first work item may correspond to the parent work item, then the LLM unit 206 may generate, via the LLM, the potential names list of child work item of the first work item in response to the final breakdown prompt. Further, the LLM unit 206 may add, via the LLM, the potential names list of child work item names of the first work item to the final breakdown prompt. Further, the LLM unit 206 may generate, via the LLM, a set of child work items corresponding to the first work item in response to the final breakdown prompt. The one or more work items may include the first work item and the set of child work items.

Further, the LLM unit 206 may send a breakdown response to the breakdown prompt unit 228. The breakdown response may include the project ID, the list of created work items, the potential names list of child work item (i.e., ‘Features’, ‘User Story’, or ‘Test Cases’) corresponding to each of the created work item. The potential names list of child work items may include interim (i.e., temporary) names The temporary potential names list may be used as a starting point for future reference while generating new child work items. Further, the breakdown prompt unit 228 may send the breakdown response to the orchestration unit 218.

Upon generating the one or more work items, the process 400 may include evaluating, by the AI ingestion unit 216, the one or more created work items, at step 414. To evaluate the one or more work items, the orchestration unit 218 may send the breakdown response to the AI ingestion unit 216. Further, the AI ingestion unit 216 may determine whether the received breakdown response is ok or not. Further, the AI ingestion unit 216 may perform multiple checks on each of the created work items. For example, the AI ingestion unit 216 may check the format of the received breakdown response (e.g., JSON, or the like). Additionally, the AI ingestion unit 216 may check whether all the required data may be present in the breakdown response or not.

Upon evaluating the one or more work items, the AI ingestion unit 216 may send an evaluation response along with the project ID to the orchestration unit 218. The evaluation response may be either ‘pass’ or ‘failure’ corresponding to the one or more checks performed by the AI ingestion unit 216. Further, the orchestration unit 218 may perform a check on the evaluation response.

If the evaluation response may be ‘pass’ and not indicate any issue at any of the multiple checks done by the AI ingestion unit 216, in such cases, the orchestration unit 218 may send the breakdown response to the defining prompt unit 230.

If the evaluation response may be ‘failure’ (i.e., one or more multiple checks may be failed during evaluation done by the AI ingestion unit 216), in such cases, the orchestration unit 218 may send back (or re-share) the selective data to the breakdown prompt unit 228. It should be noted that the orchestration unit 218 may re-share the selective data to the breakdown prompt unit 228 only for the pre-configured times (e.g., two times, three times, or the like). Additionally, the orchestration unit 218 may keep track of the number of re-shares of the selective data to the breakdown prompt unit 228.

In some embodiments, if the evaluation response may still indicate that one or more of the multiple checks may fail, in such cases, the orchestration unit 218 may send a process termination message to the user interface 202. Further, the user interface 202 may display the process termination message to the user.

Further, the process 400 may include defining, by the defining prompt unit 230, each work item of the one or more work items using the LLM, at step 416. The definition prompt unit 230 may include two prompt types (i.e., one definition prompt may be a fixed prompt, and other definition prompt may be a dynamic prompt). The definition prompt unit 230 may be used to prepare a final definition prompt using project details, the fixed prompt and the dynamic prompt.

To prepare the final definition prompt, the definition prompt unit 230 may select a fixed definition prompt (i.e., the wok item-specific definition prompt template) from a set of predefined fixed definition prompts (i.e., the set of definition prompt templates) based on the selected work item type. The definition prompt unit 230 may include four fixed definition prompts corresponding to each of the work items type (i.e., one fixed prompt for each work item type. Based on the received selected work item type, the definition prompt 230 may select one fixed definition prompt from the set of predefined definition prompts.

By way of an example, the fixed definition prompt structure may include definition of the work item being created, guidelines for creating (or updating) potential names list for child work items (i.e., while defining ‘Epic’, ‘Feature’, or ‘User Story’), fields and types of information to be included in those fields, detailed structure description (i.e., explanation of the exact JSON object structure which may be expected from the LLM unit 206 with the additional instructions for formatting that may be done with Hyper Text Markup Language (HTML)). It should be noted that this may help to handle formatting when pushing the generated work item(s) into the selected project management software via Application Programming Interface (API). Also, when the generated work items may be pushed to ‘JIRA’ which may use Atlassian Document Format (ADF) rather than HTML. In such embodiments, the response generated by the LLM unit 206 may be passed through an internal function component to translate the HTML to ADF.), minimal structure example (e.g., a basic JSON object which may show the correct key-value pairs), template and placeholder (i.e., a more fleshed-out example with descriptive placeholders that may guide the LLM unit 206 on the type of content to generate for each key).

Further, the definition prompt unit 230 may generate a dynamic definition prompt using a pre-defined prompt template and the previously generated work items (if any) associated with the selected work item type, the extracted text, the specific instructions (if any), and the one or more created work items. The definition prompt unit 230 may include a single dynamic definition prompt template for all four work items type. However, the content within fields of the dynamic definition prompt template may vary corresponding to each of the four work items type.

Upon adjusting the content of the dynamic definition prompt template corresponding to the selected work item type, the definition prompt unit 230 may add the received details to the dynamic definition prompt template to generate the dynamic definition prompt. The dynamic definition prompt may include a source label. The source label may provide the received details and the source information from where each piece of received details is coming from (e.g., the project ID and the parent work item may be received from the PMS unit 208, the created one or more work items and the potential names list (if any) may be received from the LLM unit 206, the extracted text may be obtained from the one or more requirement files, etc.) to make the LLM unit 206 aware that the received details may be coming from different sources and accordingly prioritize it.

The data in this field (i.e., the source label) may be temporarily stored in the definition prompt unit 230 corresponding to each of the received details and it is available only for ongoing prompt session duration. The dynamic definition prompt may also include the specific instructions. (e.g., if any specific instructions received from the user may also be added to the dynamic definition prompt).

Further, the definition prompt unit 230 may define (i.e., generating definition details) the one or more work items using the LLM, and the final definition prompt formed by the combination of the fixed definition prompt and the dynamic definition prompt. To define the created one or more work items, the definition prompt unit 230 may create the final definition prompt by combining the fixed dynamic prompt and the dynamic breakdown prompt corresponding to the work item. Upon creating the final definition prompt, the definition prompt unit 230 may send the final definition prompt to the LLM unit 206.

Further, the LLM unit 206 may create the definition for the work item using the LLM. Further, the LLM unit 206 may send a definition response to the definition prompt unit 230. For example, the definition response may include the project ID, the defined work item(s), and corresponding work item description corresponding to each of the work items.

In some embodiments, if the defined work item may include child work item(s), then the definition response may also include new potential names list for corresponding child work item. It should be noted that the potential names list for the corresponding child work item may be either same or different from the previously generated potential names list during generation of work items, at step 412. The LLM unit 206 may update (or change) the potential names list during work item defining process. Further, the definition prompt unit 230 may send the definition response to the orchestration unit 218.

Upon defining the work item, the process 400 may include evaluating, by the AI ingestion unit 216, the defined work item, at step 418. To evaluate the defined work item, the orchestration unit 218 may send the definition response to the AI ingestion unit 216. Further, the AI ingestion unit 216 may determine whether the received definition response is ok or not. The AI ingestion unit 216 may perform multiple checks on the defined work item.

For example, the AI ingestion unit 216 may check the format of the received definition response (i.e. if JSON or the like). Additionally, the AI ingestion unit 216 may check whether all required details (or data) may be present in the definition response or not. Upon evaluating the defined work items, the AI ingestion unit 216 may send a final evaluation response (i.e., ‘pass’ or ‘failure’) along with the project ID to the orchestration unit 218. Further, the orchestration unit 218 may perform a check on the final evaluation response.

If the final evaluation response may be ‘pass’ and may not indicate issue at any stage of the multiple checks performed by AI ingestion unit 216, then the orchestration unit 218 may send the final evaluation response to the PMS unit 208.

On the other hand, if the final evaluation response may be ‘failure’, in such cases, the orchestration unit 218 may re-share the received data to the definition prompt unit 230, at step 416. It should be noted that the orchestration unit 218 may re-share the data to the definition prompt unit 230 only for the pre-configured times. Also, the orchestration unit 218 may keep track of the number of re-shares of the data to the definition prompt unit 230. If the final evaluation response may still indicate that one or more of the multiple checks fail, then the orchestration unit 218 may send a process termination message to the user interface 202 to display it to the user.

Further, the process 400 may include pushing (or storing), by the orchestration unit 218, the work item in the PMS unit 208, at step 420. The orchestration unit 218 may send the work item, the project ID, and the generated potential names list (if any) for corresponding child work items to the PMS unit 208. Further, the PMS unit 208 may thoroughly check the received data before storing the data in the project corresponding to the project ID.

In some embodiments, the PMS unit 208 may provide a work item ID to the work item while storage. The work item ID may be used for future reference while generating a child work item(s) corresponding to the generated work item(s). Further, the PMS unit 208 may send a final work item to the orchestration unit 218. In some embodiments, the user may check the final work item from the PMS unit 208. In case, the user may find any issue corresponding to the final work item, then the user may accordingly modify the generated final work item.

Upon receiving the final work item, the process 400 may include displaying, by the user interface 202, the generated final work item to the user, at step 422. The orchestration unit 218 may send the final work item to the user interface 202. Further, the user interface 202 may display the final work item to the user on the user device. Similarly, all steps from the step 416 to step 422 may be executed in loop for each work item generated, at step 412, until each of the generated work items are defined and stored in the PMS unit 208.

Once all the created work items are generated and pushed to the PMS unit 208 successfully, the orchestration unit 218 may send a final notification to the user through the user interface 202.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

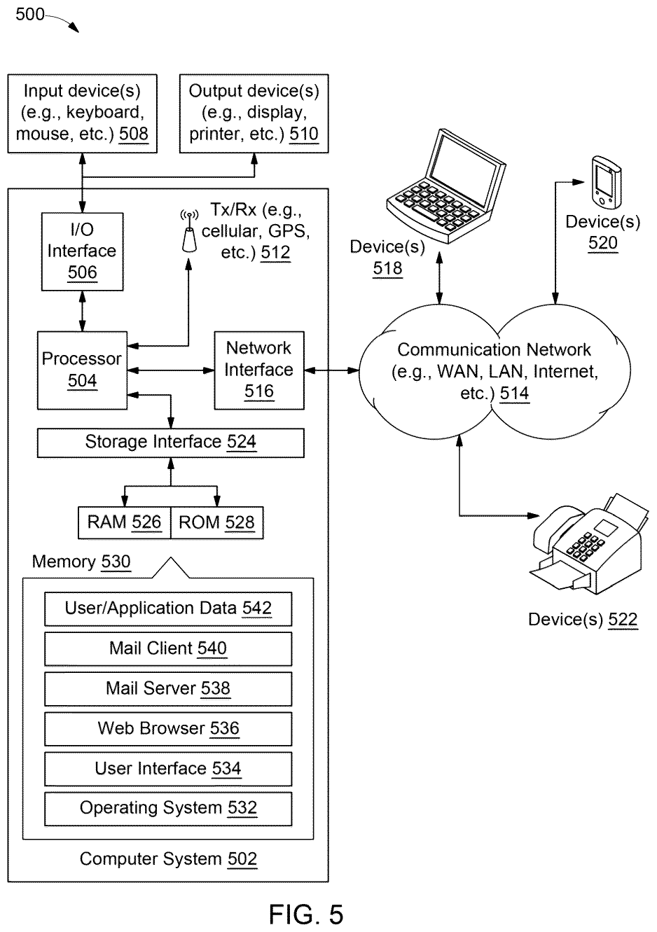

The disclosed methods and systems may be implemented on a conventional or a general-purpose computer system, such as a personal computer (PC) or server computer. Referring now to FIG. 5, a block diagram of an exemplary computer system 502 for implementing embodiments consistent with the present disclosure is illustrated. Variations of computer system 502 may be used for implementing system 500 for generating work items for PMS. The computer system 502 may include a central processing unit (“CPU” or “processor”) 504. The processor 504 may include at least one data processor for executing program components for executing user-generated or system-generated requests. A user may include a person, a person using a device such as such as those included in this disclosure, or such a device itself. The processor 504 may include specialized processing units such as integrated system (bus) controllers, memory management control units, floating point units, graphics processing units, digital signal processing units, etc. The processor 504 may include a microprocessor, such as AMD® ATHLON®, DURON® OR OPTERON®, ARM's application, embedded or secure processors, IBM® POWERPC®, INTEL® CORE® processor, ITANIUM® processor, XEON® processor, CELERON® processor or other line of processors, etc. The processor 504 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

The processor 504 may be disposed in communication with one or more input/output (I/O) devices via I/O interface 506. The I/O interface 506 may employ communication protocols/methods such as, without limitation, audio, analog, digital, monoaural, RCA, stereo, IEEE-1394, near field communication (NFC), FireWire, Camera Link®, GigE, serial bus, universal serial bus (USB), infrared, PS/2, BNC, coaxial, component, composite, digital visual interface (DVI), high-definition multimedia interface (HDMI), radio frequency (RF) antennas, S-Video, video graphics array (VGA), IEEE 502.n/b/g/n/x, Bluetooth, cellular (e.g., code-division multiple access (CDMA), high-speed packet access (HSPA+), global system for mobile communications (GSM), long-term evolution (LTE), WiMAX, or the like), etc.

Using the I/O interface 506, the computer system 502 may communicate with one or more I/O devices. For example, the input device 508 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, altimeter, gyroscope, proximity sensor, or the like), stylus, scanner, storage device, transceiver, video device/source, visors, etc. Output device 510 may be a printer, fax machine, video display (e.g., cathode ray tube (CRT), liquid crystal display (LCD), light-emitting diode (LED), plasma, or the like), audio speaker, etc. In some embodiments, a transceiver 512 may be disposed in connection with the processor 504. The transceiver may facilitate various types of wireless transmission or reception. For example, the transceiver may include an antenna operatively connected to a transceiver chip (e.g., TEXAS INSTRUMENTS® WILINK WL1283®, BROADCOM® BCM4550IUB8®, INFINEON TECHNOLOGIES® X-GOLD 618-PMB9800® transceiver, or the like), providing IEEE 802.11a/b/g/n, Bluetooth, FM, global positioning system (GPS), 2G/3G HSDPA/HSUPA communications, etc.

In some embodiments, the processor 504 may be disposed in communication with a communication network 516 via a network interface 514. The network interface 514 may communicate with the communication network 516. The network interface may employ connection protocols including, without limitation, direct connect, Ethernet (e.g., twisted pair 10/100/1000 Base T), transmission control protocol/internet protocol (TCP/IP), token ring, IEEE 602.11a/b/g/n/x, etc. The communication network 516 may include, without limitation, a direct interconnection, local area network (LAN), wide area network (WAN), wireless network (e.g., using Wireless Application Protocol), the Internet, etc. Using the network interface 514 and the communication network 516, the computer system 502 may communicate with devices 518, 520, and 522. These devices may include, without limitation, personal computer(s), server(s), fax machines, printers, scanners, various mobile devices such as cellular telephones, smartphones (e.g., APPLE® IPHONE®, BLACKBERRY® smartphone, ANDROID® based phones, etc.), tablet computers, eBook readers (AMAZON® KINDLE®, NOOK® etc.), laptop computers, notebooks, gaming consoles (MICROSOFT® XBOX®, NINTENDO® DS®, SONY® PLAYSTATION®, etc.), or the like. In some embodiments, the computer system 502 may itself embody one or more of these devices.

In some embodiments, the processor 504 may be disposed in communication with one or more memory devices 530 (e.g., RAM 526, ROM 528, etc.) via a storage interface 524. The storage interface may connect to memory devices 530 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), STD Bus, RS-232, RS-422,RS-485, I2C, SPI, Microwire, 1-Wire, IEEE 1284, Intel® QuickPathInterconnect, InfiniBand, PCIe, etc. The memory drives may further include a drum, magnetic disc drive, magneto-optical drive, optical drive, redundant array of independent discs (RAID), solid-state memory devices, solid-state drives, etc.

The memory devices 530 may store a collection of program or database components, including, without limitation, an operating system 532, user interface application 534, web browser 536, mail server 538, mail client 540, user/application data 542 (e.g., any data variables or data records discussed in this disclosure), etc. The operating system 532 may facilitate resource management and operation of the computer system 502. Examples of operating systems include, without limitation, APPLE® MACINTOSH® OS X, UNIX, Unix-like system distributions (e.g., Berkeley Software Distribution (BSD), FreeBSD, NetBSD, OpenBSD, etc.), Linux distributions (e.g., RED HAT®, UBUNTU®, KUBUNTU®, etc.), IBM® OS/2, MICROSOFT® WINDOWS® (XP®, Vista®/7/8, etc.), APPLE® IOS®, GOOGLE® ANDROID®, BLACKBERRY® OS, or the like. User interface 534 may facilitate display, execution, interaction, manipulation, or operation of program components through textual or graphical facilities. For example, user interfaces may provide computer interaction interface elements on a display system operatively connected to the computer system 502, such as cursors, icons, check boxes, menus, scrollers, windows, widgets, etc. Graphical user interfaces (GUIs) may be employed, including, without limitation, APPLE® MACINTOSH® operating systems' AQUA® platform, IBM® OS/2®, MICROSOFT® WINDOWS® (e.g., AERO®, METRO®, etc.), UNIX X-WINDOWS, web interface libraries (e.g., ACTIVEX®, JAVA®, JAVASCRIPT®, AJAX®, HTML, ADOBE® FLASH®, etc.), or the like.

In some embodiments, the computer system 502 may implement a web browser 536 stored program component. The web browser may be a hypertext viewing application, such as MICROSOFT® INTERNET EXPLORER®, GOOGLE® CHROME®, MOZILLA® FIREFOX®, APPLE® SAFARI®, etc. Secure web browsing may be provided using HTTPS (secure hypertext transport protocol), secure sockets layer (SSL), Transport Layer Security (TLS), etc. Web browsers may utilize facilities such as AJAX®, DHTML, ADOBE® FLASH®, JAVASCRIPT®, JAVA®, application programming interfaces (APIs), etc. In some embodiments, the computer system 502 may implement a mail server 538 stored program component. The mail server may be an Internet mail server such as MICROSOFT® EXCHANGE®, or the like. The mail server may utilize facilities such as ASP, ActiveX, ANSI C++/C#, MICROSOFT .NET® CGI scripts, JAVA®, JAVASCRIPT®, PERL®, PHP®, PYTHON®, WebObjects, etc. The mail server may utilize communication protocols such as internet message access protocol (IMAP), messaging application programming interface (MAPI), MICROSOFT® EXCHANGE®, post office protocol (POP), simple mail transfer protocol (SMTP), or the like. In some embodiments, the computer system 502 may implement a mail client 540 stored program component. The mail client may be a mail viewing application, such as APPLE MAIL®, MICROSOFT ENTOURAGE®, MICROSOFT OUTLOOK®, MOZILLA THUNDERBIRD®, etc.

In some embodiments, computer system 502 may store user/application data 542, such as the data, variables, records, etc. (e.g., one or more work items, input data, a work item-specific breakdown prompt template, a work item-type specific definition prompt template, one or more pre-stored projects, and the like) as described in this disclosure. Such databases may be implemented as fault-tolerant, relational, scalable, secure databases such as ORACLE® OR SYBASE®. Alternatively, such databases may be implemented using standardized data structures, such as an array, hash, linked list, struct, structured text file (e.g., XML), table, or as object-oriented databases (e.g., using OBJECTSTORE®, POET®, ZOPE®, etc.). Such databases may be consolidated or distributed, sometimes among the various computer systems discussed above in this disclosure. It is to be understood that the structure and operation of the any computer or database component may be combined, consolidated, or distributed in any working combination.

Various embodiments provide method and system for generating work items for PMS. The disclosed method and system may receive, via a user interface, input data corresponding to a user selected project from a user device. The input data may include a user selected work item type and a project identifier (ID) corresponding to the user selected project. Further, the disclosed method and system may iteratively generate one or more work items corresponding to the user selected work item type based on a final breakdown prompt using an LLM. The final breakdown prompt may include the input data and a work item-specific breakdown prompt template. Further, the disclosed method and system may validate each of the one or more work items based on a set of work item validation parameters. Upon successful validation, for each work item of the one or more work items, the disclosed method and system may generate definition details corresponding to the work item based on a final definition prompt using the LLM. The final definition prompt may include the input data, the one or more work items, and a work item-specific definition prompt template. Moreover, the disclosed method and system validate the definition details of the work item based on a set of definition validation parameters. Thereafter, upon successful validation, the disclosed method and system may render, via the user interface, the one or more work items on the user device.

Thus, the disclosed method and system try to overcome the technical problem of generating work items for PMS. The disclosed method and system may identify work items at varying levels of granularity (i.e., epic, feature, story, test case) from the provided documentation(s) and audio/video content. Further, the disclosed method and system may orchestrate static and dynamically created prompts to produce detailed descriptions and enriched content for the identified work items. Additionally, the disclosed method and system may address non-deterministic responses from LLMs to handle hallucinations. Further, the disclosed method and system may incorporate LLM outputs into well-defined API calls with rich formatting compatible with popular Agile tooling (e.g., ADO, Jira). Further, the disclosed method and system may enable to enrich existing work items to match LLM generated content and with customized instructions. Further, the disclosed method and system may capable to take multimodel data as input for processing.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for generating work items for project management system (PMS), the method comprising:
receiving, by a server via a user interface, input data corresponding to a user selected project from a user device, wherein the input data comprises a user selected work item type and a project identifier (ID) corresponding to the user selected project;
iteratively generating, by the server, one or more work items corresponding to the user selected work item type based on a final breakdown prompt using a Large Language Model (LLM), wherein the final breakdown prompt comprises the input data and a work item-specific breakdown prompt template;
validating, by the server, each of the one or more work items based on a set of work item validation parameters;
for each work item of the one or more work items,
upon successful validation, generating, by the server, definition details corresponding to the work item based on a final definition prompt using the LLM, wherein the final definition prompt comprises the input data, the one or more work items, and a work item-specific definition prompt template;
validating, by the server, the definition details of the work item based on a set of definition validation parameters; and
upon successful validation, rendering, by the server via the user interface, the one or more work items on the user device.

2. The method of claim 1, further comprising:
authenticating a set of login credentials corresponding to a user, received via the user interface from the user device;
upon successful authentication, retrieving project details corresponding to each of one or more pre-stored projects associated with the user from a project storage database;
rendering, via the user interface, the one or more pre-stored projects and the corresponding project details on the user device;
receiving, via the user interface, the user selected project from the user device, wherein the user selected project is one of the one or more pre-stored projects or a new user selected project;
identifying whether the user selected project is selected from a group consisting of the one or more pre-stored projects or the new user selected project;
when the user selected project is one of the one or more pre-stored projects, determining whether the user selected project comprises one or more previously generated parent work items;
based on the identifying and the determining, rendering, via the user interface, a set of work item types;
receiving, via the user interface, the user selected work item type from the set of work item types; and
rendering, via the user interface, an option to provide one or more requirement files and user instructions corresponding to the user selected work item type.

3. The method of claim 2, further comprising:
selecting the work item-specific breakdown prompt template from a set of breakdown prompt templates based on the user selected work item type;
generating a dynamic breakdown prompt using the input data, historical project data corresponding to the user selected project, details of a parent work item of the user selected work item type, a set of potential child work item names of the parent work item, the one or more requirement files, the user instructions, and a predefined dynamic breakdown prompt template; and
creating the final breakdown prompt based on the work item-specific breakdown prompt template and the dynamic breakdown prompt.

4. The method of claim 3, wherein iteratively generating the one or more work items comprises:
providing the final breakdown prompt to the LLM; and
iteratively generating, via the LLM, the one or more work items in response to the final breakdown prompt, wherein iteratively generating comprises, in response to the final breakdown prompt and for each of one or more iterations:
generating, via the LLM, a first work item corresponding to the user selected work item type, in response to the final breakdown prompt;
determining, via the LLM, whether a work item type of the first work item corresponds to a parent work item;
generating, via the LLM, the set of potential child work item names of the first work item in response to the final breakdown prompt, when the work item type of the first work item corresponds to the parent work item;
adding, via the LLM, the set of potential child work item names of the first work item to the final breakdown prompt; and
generating, via the LLM, a set of child work items corresponding to the first work item in response to the final breakdown prompt, wherein the one or more work items comprise the first work item and the set of child work items.

5. The method of claim 2, wherein validating the one or more work items comprises performing one or more checks on each of the one or more work items based on a first set of predefined format rules and a first set of predefined data coverage rules.

6. The method of claim 2, further comprising:
for each work item of the one or more work items,
selecting the work item-specific definition prompt template from a set of definition prompt templates based on the user selected work item type;
generating a dynamic definition prompt using the input data, the work item, historical project data corresponding to the user selected project, details of a parent work item of the user selected work item type, a set of potential child work item names of the parent work item, the one or more requirement files, the user instructions, and a predefined dynamic definition prompt template;
creating the final definition prompt based on the work item-specific definition prompt template and the dynamic definition prompt;
providing the final definition prompt to the LLM; and
generating, via the LLM, the definition details corresponding to the work item in response to the final definition prompt.

7. The method of claim 1, wherein validating the definition details of the work item comprises performing one or more checks on the definition details based on a second set of predefined format rules and a second set of predefined data coverage rules.

8. The method of claim 1, further comprising storing each of the one or more work items in the corresponding user selected project within a project storage database based on the project ID.

9. A system for generating work items for PMS, the system comprising:
a processor; and
a memory communicatively coupled to the processor, wherein the memory stores processor executable instructions, which, on execution, cause the processor to:
receive, via a user interface, input data corresponding to a user selected project from a user device, wherein the input data comprises a user selected work item type and a project identifier (ID) corresponding to the user selected project;
iteratively generate one or more work items corresponding to the user selected work item type based on a final breakdown prompt using a Large Language Model (LLM), wherein the final breakdown prompt comprises the input data and a work item-specific breakdown prompt template;
validate each of the one or more work items based on a set of work item validation parameters;
for each work item of the one or more work items,
upon successful validation, generate definition details corresponding to the work item based on a final definition prompt using the LLM, wherein the final definition prompt comprises the input data, the one or more work items, and a work item-specific definition prompt template;
validate the definition details of the work item based on a set of definition validation parameters; and
upon successful validation, render, via the user interface, the one or more work items on the user device.

10. The system of claim 9, wherein the processor executable instructions further cause the processor to:
authenticate a set of login credentials corresponding to a user, received via the user interface from the user device;
upon successful authentication, retrieve project details corresponding to each of one or more pre-stored projects associated with the user from a project storage database;
render, via the user interface, the one or more pre-stored projects and the corresponding project details on the user device;
receive, via the user interface, the user selected project from the user device, wherein the user selected project is one of the one or more pre-stored projects or a new user selected project;
identify whether the user selected project is selected from a group consisting of the one or more pre-stored projects or the new user selected project;
when the user selected project is one of the one or more pre-stored projects, determine whether the user selected project comprises one or more previously generated parent work items;
based on the identifying and the determining, render, via the user interface, a set of work item types;
receive, via the user interface, the user selected work item type from the set of work item types; and
render, via the user interface, an option to provide one or more requirement files and user instructions corresponding to the user selected work item type.

11. The system of claim 10, wherein the processor executable instructions further cause the processor to:
select the work item-specific breakdown prompt template from a set of breakdown prompt templates based on the user selected work item type;
generate a dynamic breakdown prompt using the input data, historical project data corresponding to the user selected project, details of a parent work item of the user selected work item type, a set of potential child work item names of the parent work item, the one or more requirement files, the user instructions, and a predefined dynamic breakdown prompt template; and
create the final breakdown prompt based on the work item-specific breakdown prompt template and the dynamic breakdown prompt.

12. The system of claim 11, wherein to iteratively generate the one or more work items, the processor executable instructions further cause the processor to:
provide the final breakdown prompt to the LLM; and
iteratively generate, via the LLM, the one or more work items in response to the final breakdown prompt, wherein to iteratively generate comprises, in response to the final breakdown prompt and for each of one or more iterations:
generate, via the LLM, a first work item corresponding to the user selected work item type, in response to the final breakdown prompt;
determine, via the LLM, whether a work item type of the first work item corresponds to a parent work item;
generate, via the LLM, the set of potential child work item names of the first work item in response to the final breakdown prompt, when the work item type of the first work item corresponds to the parent work item;
add, via the LLM, the set of potential child work item names of the first work item to the final breakdown prompt; and
generate, via the LLM, a set of child work items corresponding to the first work item in response to the final breakdown prompt, wherein the one or more work items comprise the first work item and the set of child work items.

13. The system of claim 10, wherein to validate the one or more work items, the processor executable instructions further cause the processor to perform one or more checks on each of the one or more work items based on a first set of predefined format rules and a first set of predefined data coverage rules.

14. The system of claim 10, wherein the processor executable instructions further cause the processor to:
for each work item of the one or more work items,
select the work item-specific definition prompt template from a set of definition prompt templates based on the user selected work item type;
generate a dynamic definition prompt using the input data, the work item, historical project data corresponding to the user selected project, details of a parent work item of the user selected work item type, a set of potential child work item names of the parent work item, the one or more requirement files, the user instructions, and a predefined dynamic definition prompt template;
create the final definition prompt based on the work item-specific definition prompt template and the dynamic definition prompt;
provide the final definition prompt to the LLM; and
generate, via the LLM, the definition details corresponding to the work item in response to the final definition prompt.

15. The system of claim 9, wherein to validate the definition details of the work item, the processor executable instructions further cause the processor to perform one or more checks on the definition details based on a second set of predefined format rules and a second set of predefined data coverage rules.

16. The system of claim 9, wherein the processor executable instructions further cause the processor to store each of the one or more work items in the corresponding user selected project within a project storage database based on the project ID.

17. A non-transitory computer-readable medium storing computer-executable instructions for generating work items for PMS, the computer-executable instructions configured for:
receiving, via a user interface, input data corresponding to a user selected project from a user device, wherein the input data comprises a user selected work item type and a project identifier (ID) corresponding to the user selected project;
iteratively generating one or more work items corresponding to the user selected work item type based on a final breakdown prompt using a Large Language Model (LLM), wherein the final breakdown prompt comprises the input data and a work item-specific breakdown prompt template;
validating each of the one or more work items based on a set of work item validation parameters;
for each work item of the one or more work items,
upon successful validation, generating definition details corresponding to the work item based on a final definition prompt using the LLM, wherein the final definition prompt comprises the input data, the one or more work items, and a work item-specific definition prompt template;
validating the definition details of the work item based on a set of definition validation parameters; and
upon successful validation, rendering, via the user interface, the one or more work items on the user device.

18. The non-transitory computer-readable medium of claim 17, wherein the computer-executable instructions are further configured for:
authenticating a set of login credentials corresponding to a user, received via the user interface from the user device;
upon successful authentication, retrieving project details corresponding to each of one or more pre-stored projects associated with the user from a project storage database;
rendering, via the user interface, the one or more pre-stored projects and the corresponding project details on the user device; and
receiving, via the user interface, the user selected project from the user device, wherein the user selected project is one of the one or more pre-stored projects or a new user selected project; and
identifying whether the user selected project is selected from a group consisting of the one or more pre-stored projects or the new user selected project;
when the user selected project is one of the one or more pre-stored projects, determining whether the user selected project comprises one or more previously generated parent work items;
based on the identifying and the determining, rendering, via the user interface, a set of work item types;
receiving, via the user interface, the user selected work item type from the set of work item types; and
rendering, via the user interface, an option to provide one or more requirement files and user instructions corresponding to the user selected work item type.

19. The non-transitory computer-readable medium of claim 18, wherein the computer-executable instructions are further configured for:
selecting the work item-specific breakdown prompt template from a set of breakdown prompt templates based on the user selected work item type;
generating a dynamic breakdown prompt using the input data, historical project data corresponding to the user selected project, details of a parent work item of the user selected work item type, a set of potential child work item names of the parent work item, the one or more requirement files, the user instructions, and a predefined dynamic breakdown prompt template; and
creating the final breakdown prompt based on the work item-specific breakdown prompt template and the dynamic breakdown prompt.

20. The non-transitory computer-readable medium of claim 19, wherein for iteratively generating the one or more work items, the computer-executable instructions are further configured for:
providing the final breakdown prompt to the LLM; and
iteratively generating, via the LLM, the one or more work items in response to the final breakdown prompt, wherein iteratively generating comprises, in response to the final breakdown prompt and for each of one or more iterations:
generating, via the LLM, a first work item corresponding to the user selected work item type, in response to the final breakdown prompt;
determining, via the LLM, whether a work item type of the first work item corresponds to a parent work item;
generating, via the LLM, the set of potential child work item names of the first work item in response to the final breakdown prompt, when the work item type of the first work item corresponds to the parent work item;
adding, via the LLM, the set of potential child work item names of the first work item to the final breakdown prompt; and
generating, via the LLM, a set of child work items corresponding to the first work item in response to the final breakdown prompt, wherein the one or more work items comprise the first work item and the set of child work items.
